(19) United States
(12) Patent Application Publication
(10) Pub. No.: US 2023/0256510 A1
(43) Pub. Date: Aug. 17, 2023

(54) PREPARATION METHOD FOR LEAD NANOWIRE

(71) Applicant: JIANGXI OUMAISI MICROELECTRONICS CO., LTD., Nanchang (CN)

(72) Inventor: Yuanfang XIANG, Nanchang (CN)

(73) Assignee: JIANGXI OUMAISI MICROELECTRONICS CO., LTD., Nanchang (CN)

(21) Appl. No.: 18/009,734

(22) PCT Filed: Jun. 4, 2021
(86) PCT No.: PCT/CN2021/098320

§ 371 Date: Dec. 11, 2022

(30) Foreign Application Priority Data
Jun. 12, 2020 (CN) 202010534821.9

(51) Int. Cl. B22F 9/24

(52) U.S. Cl. CPC B22F 9/24; B22F 2301/30

(57) ABSTRACT

A preparation method for a lead nanowire, comprising the following steps: step S10, dissolving a lead source in an organic solvent to obtain a lead-containing solution; step S20, adding acetic acid to the lead-containing solution to adjust the pH of the solution to acidity, so as to obtain a sol; step S30, mixing the sol with water, potassium hydroxide and a crystal nucleus surface modifier to obtain a mixed solution; step S40, allowing the mixed solution to undergo hydrothermal and solvothermal reactions, so as to obtain a lead nanowire. The preparation method has simple process and device, does not require expensive special device, has easily controlled process conditions and low preparation costs, and is easy for industrial production.

### CROSS-REFERENCE OF RELATED APPLICATIONS

This application claims priority from Chinese Patent Application No. 2020105348219, filed on Jun. 12, 2020 with the China Patent Office, and entitled “PREPARATION METHOD FOR LEAD NANOWIRE”, the entire content of which is incorporated herein by reference.

### TECHNICAL FIELD

The present application relates to the technical field of nanomaterial synthesis, and in particular, to a method for preparing a lead nanowire.

### BACKGROUND

Nanomaterials are a dynamic and research-rich branch in the field of nanotechnology, and have a broad application prospect especially in the fields of nanophotonic devices, electronic devices, and optoelectronic devices. Among them, metal nanowires constitute an important part of nanophotonic devices, electronic devices, and optoelectronic nanodevices, and thus become a hot spot in the research of nanomaterials. Among the numerous metal nanowires, lead nanowires have become one of the research focuses due to their advantages of superconductivity and high reactivity.

At present, there are many methods for preparing lead nanowires, such as CVD (chemical vapor deposition), molecular beam epitaxy, photolithography, or electrochemical deposition. However, these processes for preparing metal nanowires require the use of special equipment, which is costly and disadvantageous for industrial production.

### SUMMARY

According to various embodiments of the present application, a method for preparing a lead nanowire is provided.

A method for preparing a lead nanowire, including:

dissolving a lead source in an organic solvent to obtain a lead-containing solution;

adding acetic acid to the lead-containing solution to adjust pH to acidity to obtain a sol;

mixing the sol with water, potassium hydroxide, and a crystal nucleus surface modifier to obtain a mixed solution; and

subjecting the mixed solution to a hydrothermal and solvothermal reaction to obtain the lead nanowire.

In the above method for preparing the lead nanowire, the lead source is taken as the raw material and dissolved in an organic solvent. Then, acetic acid is added to adjust the pH to acidity so that lead ions are complexed with acetate ions to obtain a sol. Then, the hydrothermal and solvothermal reaction is performed under the action of potassium hydroxide and a crystal nucleus surface modifier, wherein the potassium hydroxide acts as a mineralizer to promote crystallization, and the crystal nucleus surface modifier is used to modify the surface of the crystal nucleus to improve the stability of the crystal nucleus. The lead nanowire is prepared by utilizing the high reactivity of the hydrothermal and solvothermal reaction.

The preparation method has the advantages of simple process and equipment, requiring no special equipment with high cost, easy control of process conditions, low preparation cost, and easy industrial production. The lead nanowire prepared by the preparation method has good crystal stability and high purity. It can be known from XRD that the lead nanowire obtained is of a cubic crystal form and the PDF card is #04-0686. The lead nanowire prepared by the preparation method can be widely applied to the fields of sensors, capacitors, thermistors, optoelectronic devices, satellite detection systems and the like.

In some of these embodiments, the crystal nucleus surface modifier is at least one selected from polyacrylic acid and polyvinyl alcohol. As surfactants, polyacrylic acid and polyvinyl alcohol can be adsorbed onto the surface of the crystal nucleus through their polar functional groups, thereby reducing the surface energy, increasing the stability of the crystal nucleus during crystallization, and improving the purity of the lead nanowire product.

In some of these embodiments, in the mixed solution, the crystal nucleus surface modifier is added in an amount of 0.2 g/L to 1 g/L. The addition amount of the crystal nucleus surface modifier is controlled in this range to further improve the stability of the crystal nucleus and the purity of the lead nanowire product. The aspect ratio of the lead nanowire can also be controlled by controlling the addition amount of the crystal nucleus surface modifier.

In some of these embodiments, in the mixed solution, the crystal nucleus surface modifier is added in an amount of 0.4 g/L to 0.8 g/L.

In some of these embodiments, in the mixed solution, the potassium hydroxide is added in an amount of 200 g/L to 300 g/L. The addition of potassium hydroxide can increase the activity of the reactive ions in the hydrothermal solution, and the addition amount of potassium hydroxide is controlled within this range to better promote crystallization, thereby further improving the stability of the crystal nucleus and the purity of the lead nanowire product.

In some of these embodiments, in the mixed solution, the potassium hydroxide is added in an amount of 240 g/L to 280 g/L.

In some of these embodiments, the lead source is at least one of lead acetate and lead nitrate. It will be appreciated that the lead source may also be other lead salts that are miscible with organic solvents. In an exemplary embodiment, the lead source may be lead acetate, which is capable of better complexing with acetate ions when acetic acid adjusts the pH to acidity, and acetic acid also has a certain inhibitory effect on the hydrolysis of lead acetate.

In some of these embodiments, the organic solvent is at least one of ethylene glycol monomethyl ether and ethylene glycol ethyl ether, which functions to dissolve the lead source and at the same time acts as an organic solvent for solvothermal reaction.

In some of these embodiments, the lead source is lead acetate, and the concentration of the lead-containing solution is 0.8 mol/L to 1.5 mol/L.

In some of these embodiments, the step of adding acetic acid to the lead-containing solution to adjust the pH to acidity to obtain the sol further includes:

a step of adding a stabilizer to the lead-containing solution. The stabilizer is added to improve the stability of the sol.

In some of these embodiments, the stabilizer is acetylacetone. Acetylacetone plays a role in helping to stabilize the complexation, thereby promoting the prepared sol to be more stable.

In some of these embodiments, in the sol, a volume content of the stabilizer is 15% to 20%.

In some of these embodiments, the acetic acid is added to adjust the pH to 2-4, so as to avoid the problem that subsequently obtained mixed solution begins to undergo crystallization prior to the hydrothermal and solvothermal reaction thus affecting the morphology and purity of the product.

In some of these embodiments, the step of mixing the sol with water, potassium hydroxide, and the crystal nucleus surface modifier to obtain the mixed solution includes:

first mixing the sol with the water; and then adding the potassium hydroxide and the crystal nucleus surface modifier and mixing to obtain the mixed solution;

The concentration of lead ions in the solution mixed by the sol with the water is 0.1 mol/L to 0.3 mol/L. The sol is first mixed with water and the concentration of lead ions therein is controlled in this range so that the potassium hydroxide and the crystal nucleus surface modifier are better dissolved in the solution mixed by the sol with the water and play better roles in crystallization in subsequent hydrothermal and solvothermal processes.

In some of these embodiments, the concentration of lead ions in the solution mixed by the sol with water is 0.15 mol/L to 0.25 mol/L.

In some of these embodiments, conditions for the hydrothermal and solvothermal reaction are that the reaction is performed at 170° C. to 260° C. for 18 h to 24 h. The reaction temperature in this temperature range can increase the nucleation rate and provide a higher reaction-driving force for the growth of crystal nuclei, and sufficient reaction time can be provided to ensure more sufficient growth of crystal nuclei.

### BRIEF DESCRIPTION OF THE DRAWINGS

The foregoing and other objects, features and advantages of the present application will become clearer by the more specific illustration of the preferred embodiment of the present application shown in the accompanying drawings. The same appended markings in all of the appended drawings indicate the same parts, and the appended drawings are not intentionally drawn in equal scale to actual size, the emphasis being on illustrating the main thrust of the present application.

FIG. 1 is a flow chart of a method for preparing a lead nanowire according to an embodiment of the present application.

FIG. 2 is an X-ray diffraction (XRD) pattern of a product prepared in Example 1.

FIG. 3 is a scanning electron microscope (SEM) image of the product prepared in Example 1.

FIG. 4 is an SEM image of a product prepared in Comparative Example 1.

### DETAILED DESCRIPTION OF THE EMBODIMENTS

In order to facilitate understanding of the present disclosure, the present disclosure will be described more fully hereinafter with reference to the related drawings. Preferred embodiments of the present disclosure are shown in the accompanying drawings. However, the present disclosure may be embodied in many different forms and is not limited to the embodiments described herein. Rather, providing these embodiments is to provide a thorough and complete understanding of the present disclosure.

It should be noted that when an element is referred to as being “fixed to” another element, it can be directly on the other element or an intermediate element may also be present. When an element is referred to as being “connected to” another element, it can be directly connected to another element or an intermediate element may also be present at the same time.

Unless otherwise defined, all technical and scientific terms used herein have the same meaning as commonly understood by one of ordinary skill in the art to which the present disclosure belongs. The terms used herein in the description of the present disclosure are for the purpose of describing specific embodiments only, and are not intended to limit the present disclosure. As used herein, the term “and/or” includes any and all combinations of one or more of the associated listed items.

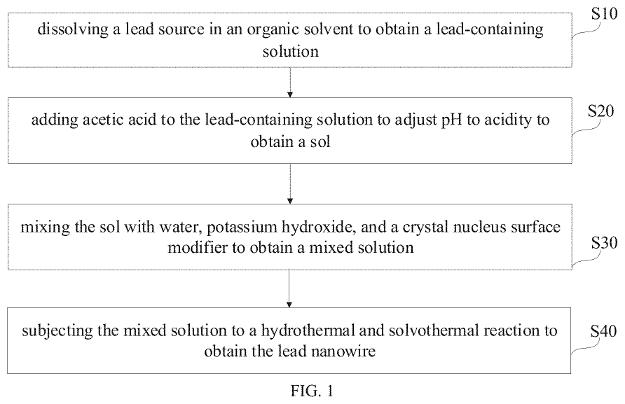

Referring to FIG. 1, an embodiment of the present application provides a method for preparing a lead nanowire, including the following steps S10 to S40.

At step S10, a lead source is dissolved in an organic solvent to obtain a lead-containing solution.

The preparation method uses the lead source as a raw material and dissolves the lead source in the organic solvent to obtain the lead-containing solution. The organic solvent is used to dissolve the lead source and also acts as an organic solvent for the solvothermal reaction.

In some of these embodiments, the lead source is at least one of lead acetate and lead nitrate. It will be appreciated that the lead source may also be other lead sources that are miscible with the organic solvent.

In some of these embodiments, the organic solvent is at least one of ethylene glycol monomethyl ether and ethylene glycol ethyl ether.

In an exemplary embodiment, the lead source may be lead acetate, which is capable of better complexing with acetate ions when acetic acid adjusts the pH to acidity.

In one embodiment, the lead source is lead acetate and the concentration of the lead-containing solution is 0.8 mol/L to 1.5 mol/L. In an exemplary embodiment, the concentration of the lead-containing solution may be 1 mol/L to 1.3 mol/L.

At step S20, acetic acid is added to the lead-containing solution to adjust the pH to acidity to obtain a sol.

In step S20, acetic acid is added to the lead-containing solution to adjust the pH to acidity, so that lead ions are complexed with acetate ions to obtain the sol. It is worth noting that the acetic acid added in step S20 can also exert a certain inhibitory effect on the hydrolysis of lead acetate.

In some of these embodiments, the step S20 of adding acetic acid to the lead-containing solution to adjust the pH to acidity to obtain the sol further includes a step of adding a stabilizer to the lead-containing solution.

In some of these embodiments, the stabilizer is acetylacetone. Acetylacetone plays a role in helping to stabilize the complexation, thereby promoting the prepared sol to be more stable.

In some of these embodiments, in the sol, a volume content of the stabilizer is 15% to 20%. The volume content of the stabilizer refers to the proportion of the volume of the stabilizer added in the sol to the volume of the sol. In an exemplary embodiment, in the sol, the volume content of the stabilizer is 16% to 18%.

In some of these embodiments, acetic acid is added to adjust the pH to 2-4 so as to avoid the problem that the subsequently obtained mixed solution begins to undergo crystallization prior to the hydrothermal and solvothermal reaction thus affecting the morphology and purity of the product. In an exemplary embodiment, after adjusting the pH, a step of uniformly mixing and then standing the pH-adjusted solution is further included.

At step S30, the sol is mixed with water, potassium hydroxide, and a crystal nucleus surface modifier to obtain a mixed solution.

Among them, potassium hydroxide acts as a mineralizer to promote crystallization, and the crystal nucleus surface modifier is used to modify the surface of the crystal nucleus to promote the stability of the crystal nucleus.

In some of these embodiments, the crystal nucleus surface modifier is a polymeric surfactant. In an exemplary embodiment, the crystal nucleus surface modifier is at least one selected from polyacrylic acid and polyvinyl alcohol. As surfactants, polyacrylic acid and polyvinyl alcohol can be adsorbed onto the surface of the crystal nucleus through their polar functional groups, thereby reducing the surface energy, increasing the stability of the crystal nucleus during crystallization, and improving the purity of the lead nanowire product.

In some of these embodiments, in the mixed solution, the crystal nucleus surface modifier is added in an amount of 0.2 g/L to 1 g/L. The addition amount of the crystal nucleus surface modifier is controlled in this range to further improve the stability of the crystal nucleus and the purity of the lead nanowire product, and the aspect ratio of the lead nanowire can be controlled by controlling the addition amount of the crystal nucleus surface modifier.

In an exemplary embodiment, in the mixed solution, the crystal nucleus surface modifier is added in an amount of 0.4 g/L to 0.8 g/L.

In some of these embodiments, in the mixed solution, the potassium hydroxide is added in an amount of 200 g/L to 300 g/L. The addition of potassium hydroxide can increase the activity of the reactive ions in the hydrothermal solution, and the addition amount of potassium hydroxide is controlled within this range to better promote crystallization, thereby further improving the stability of the crystal nucleus and the purity of the lead nanowire product. In an exemplary embodiment, in the mixed solution, the potassium hydroxide is added in an amount of 240 g/L to 280 g/L.

In some of these embodiments, the step S30 of mixing the sol with water, potassium hydroxide, and the crystal nucleus surface modifier to obtain the mixed solution includes the following steps of:

first mixing the sol with the water; and then adding the potassium hydroxide and the crystal nucleus surface modifier and mixing to obtain the mixed solution.

The concentration of lead ions in the solution mixed by the sol with the water is 0.1 mol/L to 0.3 mol/L. The sol is first mixed with water and the concentration of lead ions therein is controlled in this range so that the potassium hydroxide and the crystal nucleus surface modifier are better dissolved in the solution mixed by the sol with the water and paly better roles in crystallization in subsequent hydrothermal and solvothermal processes. In an exemplary embodiment, the concentration of lead ions in the solution mixed by the sol with the water is 0.15 mol/L to 0.25 mol/L.

At step S40, the mixed solution is subjected to a hydrothermal and solvothermal reaction to obtain the lead nanowire.

In some of these embodiments, conditions for the hydrothermal and solvothermal reaction are that the reaction is performed at 170° C. to 260° C. for 18 h to 24 h. The reaction temperature in this temperature range can increase the nucleation rate and provide a higher reaction-driving force for the growth of crystal nuclei, and sufficient reaction time can be provided to ensure more sufficient growth of crystal nuclei. In an exemplary embodiment, the conditions for the hydrothermal and solvothermal reaction are that the reaction is performed at 200° C. to 240° C. for 20 h to 24 h.

In some of these embodiments, after the hydrothermal or solvothermal reaction and prior to the step of obtaining the lead nanowire, the steps of washing the reaction product with water and ethanol, filtering, and drying are also included.

In the above method for preparing the lead nanowire, the lead source is taken as the raw material and dissolved in an organic solvent. Then, acetic acid is added to adjust the pH to acidity so that lead ions are complexed with acetate ions to obtain a sol. Then, the hydrothermal and solvothermal reaction is performed under the action of potassium hydroxide and a crystal nucleus surface modifier. The potassium hydroxide acts as a mineralizer to promote crystallization, and the crystal nucleus surface modifier is used to modify the surface of the crystal nucleus to improve the stability of the crystal nucleus. The lead nanowire is prepared by utilizing the high reactivity of the solvothermal reaction.

The preparation method has the advantages of simple process and equipment, requiring no special equipment with high cost, easy control of process conditions, low preparation cost, and easy industrial production, which fills the blank of preparing metal nanowires by the hydrothermal and solvothermal method.

In addition, the lead nanowire prepared by the preparation method has good crystal stability and high purity. It can be known from XRD that the lead nanowire obtained is of a cubic crystal form and the PDF card is #04-0686. The lead nanowire prepared by the preparation method can be widely applied to the fields of sensors, capacitors, thermistors, optoelectronic devices, satellite detection systems and the like.

The following are specific examples.

### Example 1

A preparation of a lead nanowire by a hydrothermal and solvothermal method includes the following steps.

1) A certain mass of PbC₄H₆O₄·3H₂O was weighed into a clean beaker, and ethylene glycol monomethyl ether was added, which were stirred with a magnetic stirrer for 50 minutes until homogeneous to prepare a 1 mol/L PbC₄H₆O₄·3H₂O solution.

2) Acetylacetone was added to the above solution, and acetic acid was added to adjust the pH value of the solution to 4, and the solution was magnetically stirred for 3 hours, and then the solution was left to stand in air for 24 hours to form a homogeneous, transparent, and pale yellow sol. The amount of acetylacetone added was controlled so that its volume content in the sol was 15%.

3) The above sol was mixed with deionized water, and the concentration of lead ions after mixing was 0.2 mol/L.

4) PAA (polyacrylic acid, crystal nucleus surface modifier) and KOH (mineralizer) were added into the mixed material in step 3) and mixed to obtain a mixed solution, so that the concentrations of PAA (polyacrylic acid) and KOH in the mixed solution were 0.5 g/L and 250 g/L, respectively.

5) After stirring, the mixed solution was transferred to the reaction kettle, and the volume of the reaction material in the inner tank of the reaction kettle was controlled to reach 70%˜90% of the volume of the inner tank of the reaction kettle. The reaction kettle was placed at 200° C. for 20 h. After the reaction was finished, the reaction kettle was naturally cooled to room temperature, and after the kettle was unloaded, the reaction product was repeatedly washed with deionized water and absolute ethanol, filtered and dried to obtain the lead nanowire.

### Example 2

A preparation of a lead nanowire by a hydrothermal and solvothermal method includes the following steps.

1) A certain mass of PbC₄H₆O₄·3H₂O was weighed into a clean beaker, and ethylene glycol monomethyl ether was added, which were stirred with a magnetic stirrer for 50 minutes until homogeneous to prepare a 1 mol/L PbC₄H₆O₄·3H₂O solution.

2) Acetylacetone was added to the above solution, and acetic acid was added to adjust the pH value of the solution to 2, and the solution was magnetically stirred for 3 hours, and then the solution was left to stand in air for 24 hours to form a homogeneous, transparent, and pale yellow sol. The amount of acetylacetone added was controlled so that its volume content in the sol was 15%.

3) The above sol was mixed with deionized water, and the concentration of lead ions after mixing was 0.2 mol/L.

4) PAA (polyacrylic acid, crystal nucleus surface modifier) and KOH (mineralizer) were added into the mixed material in step 3) and mixed to obtain a mixed solution, so that the concentrations of PAA (polyacrylic acid) and KOH in the mixed solution were 0.5 g/L and 250 g/L, respectively.

5) After stirring, the mixed solution was transferred to the reaction kettle, and the volume of the reaction material in the inner tank of the reaction kettle was controlled to reach 70%˜90% of the volume of the inner tank of the reaction kettle. The reaction kettle was placed at 200° C. for 20 h. After the reaction was finished, the reaction kettle was naturally cooled to room temperature, and after the kettle was unloaded, the reaction product was repeatedly washed with deionized water and absolute ethanol, filtered and dried to obtain the lead nanowire.

### Example 3

A preparation of a lead nanowire by a hydrothermal and solvothermal method includes the following steps.

1) A certain mass of PbC₄H₆O₄·3H₂O was weighed into a clean beaker, and ethylene glycol monomethyl ether was added, which were stirred with a magnetic stirrer for 50 minutes until homogeneous to prepare a 1 mol/L PbC₄H₆O₄·3H₂O solution.

2) Acetylacetone was added to the above solution, and acetic acid was added to adjust the pH value of the solution to 4, and the solution was magnetically stirred for 3 hours, and then the solution was left to stand in air for 24 hours to form a homogeneous, transparent, and pale yellow sol. The amount of acetylacetone added was controlled so that its volume content in the sol was 20%.

3) The above sol was mixed with deionized water, and the concentration of lead ions after mixing was 0.2 mol/L.

4) PAA (polyacrylic acid, crystal nucleus surface modifier) and KOH (mineralizer) were added into the mixed material in step 3) and mixed to obtain a mixed solution, so that the concentrations of PAA (polyacrylic acid) and KOH in the mixed solution were 0.5 g/L and 250 g/L, respectively.

5) After stirring, the mixed solution was transferred to the reaction kettle, and the volume of the reaction material in the inner tank of the reaction kettle was controlled to reach 70%˜90% of the volume of the inner tank of the reaction kettle. The reaction kettle was placed at 200° C. for 20 h. After the reaction was finished, the reaction kettle was naturally cooled to room temperature, and after the kettle was unloaded, the reaction product was repeatedly washed with deionized water and absolute ethanol, filtered and dried to obtain the lead nanowire.

### Example 4

A preparation of a lead nanowire by a hydrothermal and solvothermal method includes the following steps.

1) A certain mass of PbC₄H₆O₄·3H₂O was weighed into a clean beaker, and ethylene glycol monomethyl ether was added, which were stirred with a magnetic stirrer for 50 minutes until homogeneous to prepare a 1 mol/L PbC₄H₆O₄·3H₂O solution.

2) Acetylacetone was added to the above solution, and acetic acid was added to adjust the pH value of the solution to 4, and the solution was magnetically stirred for 3 hours, and then the solution was left to stand in air for 24 hours to form a homogeneous, transparent, and pale yellow sol. The amount of acetylacetone added was controlled so that its volume content in the sol was 18%.

3) The above sol was mixed with deionized water, and the concentration of lead ions after mixing was 0.2 mol/L.

4) PAA (polyacrylic acid, crystal nucleus surface modifier) and KOH (mineralizer) were added into the mixed material in step 3) and mixed to obtain a mixed solution, so that the concentrations of PAA (polyacrylic acid) and KOH in the mixed solution were 0.5 g/L and 250 g/L, respectively.

5) After stirring, the mixed solution was transferred to the reaction kettle, and the volume of the reaction material in the inner tank of the reaction kettle was controlled to reach 70%˜90% of the volume of the inner tank of the reaction kettle. The reaction kettle was placed at 200° C. for 20 h. After the reaction was finished, the reaction kettle was naturally cooled to room temperature, and after the kettle was unloaded, the reaction product was repeatedly washed with deionized water and absolute ethanol, filtered and dried to obtain the lead nanowire.

### Example 5

A preparation of a lead nanowire by a hydrothermal and solvothermal method includes the following steps.

1) A certain mass of PbC₄H₆O₄·3H₂O was weighed into a clean beaker, and ethylene glycol monomethyl ether was added, which were stirred with a magnetic stirrer for 50 minutes until homogeneous to prepare a 1 mol/L PbC₄H₆O₄·3H₂O solution.

2) Acetylacetone was added to the above solution, and acetic acid was added to adjust the pH value of the solution to 4, and the solution was magnetically stirred for 3 hours, and then the solution was left to stand in air for 24 hours to form a homogeneous, transparent, and pale yellow sol. The amount of acetylacetone added was controlled so that its volume content in the sol was 15%.

3) The above sol was mixed with deionized water, and the concentration of lead ions after mixing was 0.2 mol/L.

4) PAA (polyacrylic acid, crystal nucleus surface modifier) and KOH (mineralizer) were added into the mixed material in step 3) and mixed to obtain a mixed solution, so that the concentrations of PAA (polyacrylic acid) and KOH in the mixed solution were 1 g/L and 200 g/L, respectively.

5) After stirring, the mixed solution was transferred to the reaction kettle, and the volume of the reaction material in the inner tank of the reaction kettle was controlled to reach 70%˜90% of the volume of the inner tank of the reaction kettle. The reaction kettle was placed at 200° C. for 20 h. After the reaction was finished, the reaction kettle was naturally cooled to room temperature, and after the kettle was unloaded, the reaction product was repeatedly washed with deionized water and absolute ethanol, filtered and dried to obtain the lead nanowire.

### Example 6

A preparation of a lead nanowire by a hydrothermal and solvothermal method includes the following steps.

1) A certain mass of PbC₄H₆O₄·3H₂O was weighed into a clean beaker, and ethylene glycol monomethyl ether was added, which were stirred with a magnetic stirrer for 50 minutes until homogeneous to prepare a 1 mol/L PbC₄H₆O₄·3H₂O solution.

2) Acetylacetone was added to the above solution, and acetic acid was added to adjust the pH value of the solution to 4, and the solution was magnetically stirred for 3 hours, and then the solution was left to stand in air for 24 hours to form a homogeneous, transparent, and pale yellow sol. The amount of acetylacetone added was controlled so that its volume content in the sol was 15%.

3) The above sol was mixed with deionized water, and the concentration of lead ions after mixing was 0.2 mol/L.

4) PAA (polyacrylic acid, crystal nucleus surface modifier) and KOH (mineralizer) were added into the mixed material in step 3) and mixed to obtain a mixed solution, so that the concentrations of PAA (polyacrylic acid) and KOH in the mixed solution were 2 g/L and 300 g/L, respectively.

5) After stirring, the mixed solution was transferred to the reaction kettle, and the volume of the reaction material in the inner tank of the reaction kettle was controlled to reach 70%˜90% of the volume of the inner tank of the reaction kettle. The reaction kettle was placed at 200° C. for 20 h. After the reaction was finished, the reaction kettle was naturally cooled to room temperature, and after the kettle was unloaded, the reaction product was repeatedly washed with deionized water and absolute ethanol, filtered and dried to obtain the lead nanowire.

### Example 7

A preparation of a lead nanowire by a hydrothermal and solvothermal method includes the following steps.

1) A certain mass of PbC₄H₆O₄·3H₂O was weighed into a clean beaker, and ethylene glycol monomethyl ether was added, which were stirred with a magnetic stirrer for 50 minutes until homogeneous to prepare a 1 mol/L PbC₄H₆O₄·3H₂O solution.

2) Acetylacetone was added to the above solution, and acetic acid was added to adjust the pH value of the solution to 4, and the solution was magnetically stirred for 3 hours, and then the solution was left to stand in air for 24 hours to form a homogeneous, transparent, and pale yellow sol. The amount of acetylacetone added was controlled so that its volume content in the sol was 15%.

3) The above sol was mixed with deionized water, and the concentration of lead ions after mixing was 0.2 mol/L.

4) PAA (polyacrylic acid, crystal nucleus surface modifier) and KOH (mineralizer) were added into the mixed material in step 3) and mixed to obtain a mixed solution, so that the concentrations of PAA (polyacrylic acid) and KOH in the mixed solution were 0.5 g/L and 250 g/L, respectively.

5) After stirring, the mixed solution was transferred to the reaction kettle, and the volume of the reaction material in the inner tank of the reaction kettle was controlled to reach 70%˜90% of the volume of the inner tank of the reaction kettle. The reaction kettle was placed at 260° C. for 18 h. After the reaction was finished, the reaction kettle was naturally cooled to room temperature, and after the kettle was unloaded, the reaction product was repeatedly washed with deionized water and absolute ethanol, filtered and dried to obtain the lead nanowire.

### Example 8

A preparation of a lead nanowire by a hydrothermal and solvothermal method includes the following steps.

1) A certain mass of PbC₄H₆O₄·3H₂O was weighed into a clean beaker, and ethylene glycol monomethyl ether was added, which were stirred with a magnetic stirrer for 50 minutes until homogeneous to prepare a 1 mol/L PbC₄H₆O₄·3H₂O solution.

2) Acetylacetone was added to the above solution, and acetic acid was added to adjust the pH value of the solution to 4, and the solution was magnetically stirred for 3 hours, and then the solution was left to stand in air for 24 hours to form a homogeneous, transparent, and pale yellow sol. The amount of acetylacetone added was controlled so that its volume content in the sol was 15%.

3) The above sol was mixed with deionized water, and the concentration of lead ions after mixing was 0.2 mol/L.

4) PAA (polyacrylic acid, crystal nucleus surface modifier) and KOH (mineralizer) were added into the mixed material in step 3) and mixed to obtain a mixed solution, so that the concentrations of PAA (polyacrylic acid) and KOH in the mixed solution were 0.5 g/L and 250 g/L, respectively.

5) After stirring, the mixed solution was transferred to the reaction kettle, and the volume of the reaction material in the inner tank of the reaction kettle was controlled to reach 70%˜90% of the volume of the inner tank of the reaction kettle. The reaction kettle was placed at 170° C. for 24 h. After the reaction was finished, the reaction kettle was naturally cooled to room temperature, and after the kettle was unloaded, the reaction product was repeatedly washed with deionized water and absolute ethanol, filtered and dried to obtain the lead nanowire.

### Example 9

A preparation of a lead nanowire by a hydrothermal and solvothermal method includes the following steps.

1) A certain mass of PbC₄H₆O₄·3H₂O was weighed into a clean beaker, and ethylene glycol monomethyl ether was added, which were stirred with a magnetic stirrer for 50 minutes until homogeneous to prepare a 1 mol/L PbC₄H₆O₄·3H₂O solution.

2) No acetylacetone was added to the above solution, and acetic acid was added to adjust the pH value of the solution to 4, and the solution was magnetically stirred for 3 hours, and then the solution was left to stand in air for 24 hours to form a homogeneous, transparent, and pale yellow sol.

3) The above sol was mixed with deionized water, and the concentration of lead ions after mixing was 0.2 mol/L.

4) PAA (polyacrylic acid, crystal nucleus surface modifier) and KOH (mineralizer) were added into the mixed material in step 3) and mixed to obtain a mixed solution, so that the concentrations of PAA (polyacrylic acid) and KOH in the mixed solution were 0.5 g/L and 250 g/L, respectively.

5) After stirring, the mixed solution was transferred to the reaction kettle, and the volume of the reaction material in the inner tank of the reaction kettle was controlled to reach 70%˜90% of the volume of the inner tank of the reaction kettle. The reaction kettle was placed at 200° C. for 20 h. After the reaction was finished, the reaction kettle was naturally cooled to room temperature, and after the kettle was unloaded, the reaction product was repeatedly washed with deionized water and absolute ethanol, filtered and dried to obtain the lead nanowire.

### Example 10

A preparation of a lead nanowire by a hydrothermal and solvothermal method includes the following steps.

1) A certain mass of PbC₄H₆O₄-3H₂O was weighed into a clean beaker, and ethylene glycol monomethyl ether was added, which were stirred with a magnetic stirrer for 50 minutes until homogeneous to prepare a 1 mol/L PbC₄H₆O₄·3H₂O solution.

2) Acetylacetone was added to the above solution, and acetic acid was added to adjust the pH value of the solution to 4, and the solution was magnetically stirred for 3 hours, and then the solution was left to stand in air for 24 hours to form a homogeneous, transparent, and pale yellow sol. The amount of acetylacetone added was controlled so that its volume content in the sol was 15%.

3) The above sol was mixed with deionized water, and the concentration of lead ions after mixing was 0.2 mol/L.

4) PVA (polyvinyl alcohol, crystal nucleus surface modifier) and KOH (mineralizer) were added into the mixed material in step 3) and mixed to obtain a mixed solution, so that the concentrations of PVA (polyvinyl alcohol) and KOH in the mixed solution were 0.5 g/L and 250 g/L, respectively.

5) After stirring, the mixed solution was transferred to the reaction kettle, and the volume of the reaction material in the inner tank of the reaction kettle was controlled to reach 70%˜90% of the volume of the inner tank of the reaction kettle. The reaction kettle was placed at 200° C. for 20 h. After the reaction was finished, the reaction kettle was naturally cooled to room temperature, and after the kettle was unloaded, the reaction product was repeatedly washed with deionized water and absolute ethanol, filtered and dried to obtain the lead nanowire.

### Comparative Example 1

A preparation of a lead nanowire by a hydrothermal and solvothermal method includes the following steps.

1) A certain mass of PbC₄H₆O₄·3H₂O was weighed into a clean beaker, and ethylene glycol monomethyl ether was added, which were stirred with a magnetic stirrer for 50 minutes until homogeneous to prepare a 1 mol/L PbC₄H₆O₄·3H₂O solution.

2) Acetylacetone was added to the above solution, and acetic acid was added to adjust the pH value of the solution to 4, and the solution was magnetically stirred for 3 hours, and then the solution was left to stand in air for 24 hours to form a homogeneous, transparent, and pale yellow sol. The amount of acetylacetone added was controlled so that its volume content in the sol was 15%.

3) The above sol was mixed with deionized water, and the concentration of lead ions after mixing was 0.2 mol/L.

4) PAA (polyacrylic acid) and NaOH were added into the mixed material in step 3) and mixed to obtain a mixed solution, so that the concentrations of PAA (polyacrylic acid) and NaOH in the mixed solution were 0.5 g/L and 250 g/L, respectively.

5) After stirring, the mixed solution was transferred to the reaction kettle, and the volume of the reaction material in the inner tank of the reaction kettle was controlled to reach 70%˜90% of the volume of the inner tank of the reaction kettle. The reaction kettle was placed at 200° C. for 20 h. After the reaction was finished, the reaction kettle was naturally cooled to room temperature, and after the kettle was unloaded, the reaction product was repeatedly washed with deionized water and absolute ethanol, filtered and dried to obtain amorphous lead.

The reaction process parameters of Examples 1 to 10 and Comparative Example 1 are shown in Table 1 below.

TABLE 1

| | Concentration | | Addition | Crystal | Addition | Conditions |
|---|---|---|---|---|---|---|
| | of lead | | amount | nucleus | amount | of |
| | acetate | pH | of | surface | of | solvothermal |
| Parameter | solution | value | acetylacetone | modifier | mineralizer | reaction |
| Example 1 | 1 mol/L | 4 | 15% | PAA | KOH | 200° C., |
| | | | | 0.5 g/L | 250 g/L | 20 h |
| Example 2 | 1 mol/L | 2 | 15% | PAA | KOH | 200° C., |
| | | | | 0.5 g/L | 250 g/L | 20 h |
| Example 3 | 1 mol/L | 4 | 20% | PAA | KOH | 200° C., |
| | | | | 0.5 g/L | 250 g/L | 20 h |
| Example 4 | 1 mol/L | 4 | 18% | PAA | KOH | 200° C., |
| | | | | 1 g/L | 200 g/L | 20 h |
| Example 5 | 1 mol/L | 4 | 15% | PAA | KOH | 200° C., |
| | | | | 1 g/L | 200 g/L | 20 h |
| Example 6 | 1 mol/L | 4 | 15% | PAA | KOH | 200° C., |
| | | | | 0.2 g/L | 300 g/L | 20 h |
| Example 7 | 1 mol/L | 4 | 15% | PAA | KOH | 260° C., |
| | | | | 0.5 g/L | 250 g/L | 18h |
| Example 8 | 1 mol/L | 4 | 15% | PAA | KOH | 170° C., |
| | | | | 0.5 g/L | 250 g/L | 24 h |
| Example 9 | 1 mol/L | 4 | 0 | PAA | KOH | 200° C., |
| | | | | 0.5 g/L | 250 g/L | 20 h |
| Example 10 | 1 mol/L | 4 | 15% | PVA | KOH | 200° C., |
| | | | | 0.5 g/L | 250 g/L | 20 h |
| Comparative | 1 mol/L | 4 | 15% | PAA | NaOH | 200° C., |
| Example 1 | | | | 0.5 g/L | 250 g/L | 20 h |

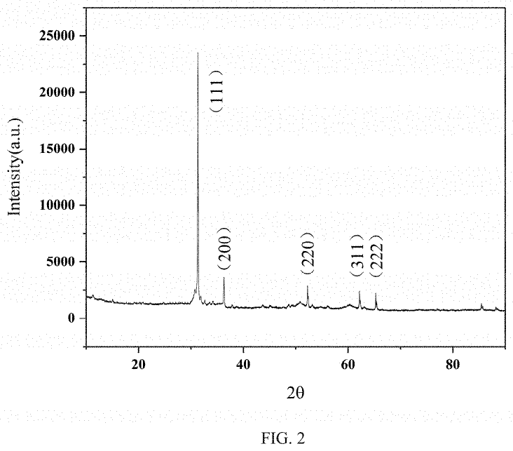

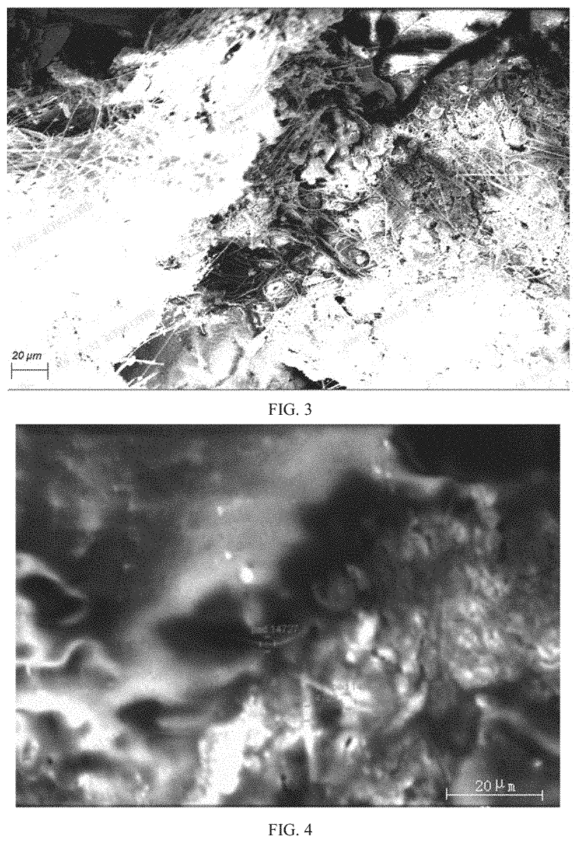

SEM (scanning electron microscope) detection and XRD performance detections are carried out on the products obtained in Examples 1 to 10 and Comparative Example 1. According to the detection results, the products obtained in Examples 1 to 10 are all nanowire-shaped metallic lead. Specifically, the XRD pattern of the product obtained in Example 1 is shown in FIG. 2. It can be seen from FIG. 2 that the diffraction peak of the XRD is very strong, indicating that it has good crystallization and high purity. In addition, by comparison, it is found that the product obtained in Example 1 is a metal lead in a cubic crystal form, and the PDF card is #04-0686. The SEM image of the product obtained in Example 1 is shown in FIG. 3, and it can be seen from FIG. 3 that the morphology of the product is obvious nanowire-like. The SEM image of the product obtained in Comparative Example 1 is shown in FIG. 4, from which it can be seen that the product prepared in Comparative Example 1 does not have metal lead with the specific morphology, and lead nanowires cannot be prepared.

The technical features of the above-described embodiments can be combined arbitrarily. To simplify the description, not all possible combinations of the technical features in the above embodiments are described. However, all of the combinations of these technical features should be considered as being fallen within the scope of the present disclosure, as long as such combinations do not contradict with each other.

The foregoing embodiments merely illustrate some embodiments of the present disclosure, and descriptions thereof are relatively specific and detailed. However, it should not be understood as a limitation to the patent scope of the present disclosure. It should be noted that, a person of ordinary skill in the art may further make some variations and improvements without departing from the concept of the present disclosure, and the variations and improvements falls in the protection scope of the present disclosure. Therefore, the protection scope of the present disclosure shall be subject to the appended claims.

What is claimed is:

1. A method for preparing a lead nanowire, comprising:
dissolving a lead source in an organic solvent to obtain a lead-containing solution;
adding acetic acid to the lead-containing solution to adjust pH to acidity to obtain a sol;
mixing the sol with water, potassium hydroxide, and a crystal nucleus surface modifier to obtain a mixed solution; and
subjecting the mixed solution to a hydrothermal and solvothermal reaction to obtain the lead nanowire.

2. The method for preparing the lead nanowire according to claim 1, wherein the crystal nucleus surface modifier is at least one selected from polyacrylic acid and polyvinyl alcohol.

3. The method for preparing the lead nanowire according to claim 1, wherein in the mixed solution, the crystal nucleus surface modifier is added in an amount of 0.2 g/L to 1 g/L.

4. The method for preparing the lead nanowire according to claim 3, wherein in the mixed solution, the crystal nucleus surface modifier is added in an amount of 0.4 g/L to 0.8 g/L.

5. The method for preparing the lead nanowire according to claim 1, wherein in the mixed solution, the potassium hydroxide is added in an amount of 200 g/L to 300 g/L.

6. The method for preparing the lead nanowire according to claim 5, wherein in the mixed solution, the potassium hydroxide is added in an amount of 240 g/L to 280 g/L.

7. The method for preparing the lead nanowire according to claim 1, wherein the lead source is at least one of lead acetate and lead nitrate.

8. The method for preparing the lead nanowire according to claim 1, wherein the organic solvent is at least one of ethylene glycol monomethyl ether and ethylene glycol ethyl ether.

9. The method for preparing the lead nanowire according to claim 7, wherein the lead source is lead acetate, and a concentration of the lead-containing solution is 0.8 mol/L to 1.5 mol/L.

10. The method for preparing the lead nanowire according to claim 1, wherein the step of adding acetic acid to the lead-containing solution to adjust the pH to acidity to obtain the sol further comprises: adding a stabilizer to the lead-containing solution.

11. The method for preparing the lead nanowire according to claim 10, wherein the stabilizer is acetylacetone.

12. The method for preparing the lead nanowire according to claim 10, wherein in the sol, a volume content of the stabilizer is 15% to 20%.

13. The method for preparing the lead nanowire according to claim 1, wherein the acetic acid is added to adjust pH to 2-4.

14. The method for preparing the lead nanowire according to claim 1, wherein the step of mixing the sol with water, potassium hydroxide, and the crystal nucleus surface modifier to obtain the mixed solution comprises:
first uniformly mixing the sol with the water; and
adding the potassium hydroxide and the crystal nucleus surface modifier and mixing to obtain the mixed solution;
wherein a concentration of lead ions in the solution mixed by the sol with water is 0.1 mol/L to 0.3 mol/L.

15. The method for preparing the lead nanowire according to claim 14, wherein the concentration of the lead ions in the solution mixed by the sol with water is 0.15 mol/L to 0.25 mol/L.

16. The method for preparing the lead nanowire according to claim 1, wherein conditions for the hydrothermal and solvothermal reaction are that the reaction is performed at 170° C. to 260° C. for 18 h to 24 h.
